(19) United States
(12) Patent Application Publication
(10) Pub. No.: US 2024/0330930 A1
(43) Pub. Date: Oct. 3, 2024

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Akira KADODA, Kanagawa (JP)

(73) Assignee: FUJIFILM Business Innovation Corp., Tokyo (JP)

(21) Appl. No.: 18/454,087

(22) Filed: Aug. 23, 2023

(30) Foreign Application Priority Data
Mar. 28, 2023 (JP) 2023-051950

(51) Int. Cl. G06Q 20/40; G06Q 20/34

(52) U.S. Cl. CPC G06Q 20/4014; G06Q 20/34

(57) ABSTRACT

An information processing system includes a processor configured to: in accepting registration of a process to be performed by a processing apparatus, receive identifying information of a card or an information processing terminal capable of wireless communication and information to be handled in the process and register the process in association with the identifying information, the identifying information being associated with the wireless communication; in performing the registered process, receive the identifying information obtained by the processing apparatus via the wireless communication from the card or the information processing terminal; and transmit to the processing apparatus the information to be handled in the process registered in association with the received identifying information.

### CROSS-REFERENCE TO RELATED APPLICATIONS

This application is based on and claims priority under 35 USC 119 from Japanese Patent Application No. 2023-051950 filed Mar. 28, 2023.

### BACKGROUND

### (i) Technical Field

The present disclosure relates to an information processing system, an information processing method, and a non-transitory computer readable medium.

### (ii) Related Art

Japanese Unexamined Patent Application Publication No. 2019-57146 discloses an information processing apparatus including a transmitting unit configured to transmit to a cloud server processing-command information to cause a processing apparatus to execute a process, a receiving unit configured to receive process-identifying information issued by the cloud server to identify the process in response to the processing-command information that has been received by the cloud server, a reading unit configured to read apparatus-identifying information displayed by the processing apparatus to identify the processing apparatus, and an executing-command unit configured to, based on the process-identifying information that has been received and the apparatus-identifying information that has been read, cause the processing apparatus corresponding to the apparatus-identifying information to execute the process.

### SUMMARY

A processing apparatus installed in a place such as a convenience store is sometimes used to execute a process registered in an information processing apparatus including a cloud server. When a registered process is executed, an image of process-identifying information displayed on the screen of the processing apparatus is captured by a camera function of a device such as a mobile terminal apparatus, and a command to cause the processing apparatus to execute the registered process is sent from the mobile terminal apparatus based on the captured information, thereby enabling the processing apparatus to execute the process without the necessity of the process-identifying information issued by the information processing apparatus being input to the processing apparatus. Unfortunately, an image of the screen of the processing apparatus needs to be captured by using the mobile terminal apparatus, and thereafter an output command needs to be sent from the mobile terminal apparatus to the processing apparatus, leading to poor usability.

Thus, aspects of non-limiting embodiments of the present disclosure relate to providing an information processing system, an information processing method, and a non-transitory computer readable medium that can provide better usability in causing a processing apparatus to execute a registered process than a system in which a mobile terminal apparatus is used to send a command to the processing apparatus to execute the registered process based on the information obtained from the image of the process-identifying information captured by the imaging function of the mobile terminal apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: in accepting registration of a process to be performed by a processing apparatus, receive identifying information of a card or an information processing terminal capable of wireless communication and information to be handled in the process and register the process in association with the identifying information, the identifying information being associated with the wireless communication; in performing the registered process, receive the identifying information obtained by the processing apparatus via the wireless communication from the card or the information processing terminal; and transmit to the processing apparatus the information to be handled in the process registered in association with the received identifying information.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system including an image forming apparatus according to the present exemplary embodiment;

FIG. 2 is a block diagram depicting central components of the electrical system of the image forming apparatus according to the present exemplary embodiment;

FIG. 3 is a block diagram depicting central components of respective electrical systems of a cloud server and an information processing terminal according to the present exemplary embodiment;

FIG. 4 is an illustration depicting a schematic configuration of a printing service provided by the cloud server in the information processing system according to the present exemplary embodiment;

FIG. 5 is an illustration for describing a process of registering two jobs in the cloud server and outputting the two jobs;

FIG. 6 is an illustration depicting examples of the screen that depends on the condition of the information processing terminal and how the application is configured;

FIG. 7 is an illustration for describing examples of how the screen changes when the image forming apparatus outputs a job;

FIG. 8 is a flowchart depicting an example of a process performed by the information processing terminal when a job is registered in the information processing system according to the present exemplary embodiment;

FIG. 9 is a flowchart depicting an example of a process performed by the cloud server when a job is registered in the information processing system according to the present exemplary embodiment;

FIG. 10 is a flowchart depicting an example of a process performed by the image forming apparatus when a registered job is output by the image forming apparatus in the information processing system according to the present exemplary embodiment; and

FIG. 11 is a flowchart depicting an example of a process performed by the cloud server after a job is registered in the information processing system according to the present exemplary embodiment.

### DETAILED DESCRIPTION

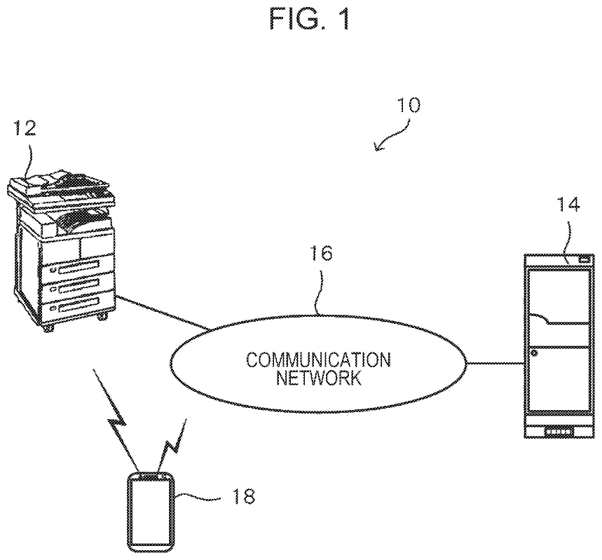

Hereinafter, an exemplary embodiment of the present disclosure will be described in detail with reference to the drawings. FIG. 1 is an illustration depicting a schematic configuration of an information processing system including an image forming apparatus according to the present exemplary embodiment.

An information processing system 10 according to the present exemplary embodiment includes an image forming apparatus 12 as an example of a processing apparatus, a cloud server 14, and an information processing terminal 18 capable of wireless communication as depicted in FIG. 1.

The image forming apparatus 12, the cloud server 14, and the information processing terminal 18 are connected to each other by using a communication network 16, such as a wide area network (WAN) or the Internet. The image forming apparatus 12, the cloud server 14, and the information processing terminal 18 are capable of transmitting and receiving various kinds of data to and from each other via the communication network 16.

The image forming apparatus 12 is installed, for example, in a place such as a supermarket or a convenience store and is configured to provide multiple functions for a fec, which include a facsimile function, an image reading function, an image forming function, a copying function, a storage function for storing data such as image information, and a transmitting function for transmitting data such as image information.

The cloud server 14 is configured to accept a request for printing from the information processing terminal 18 and provide a printing service in which the image forming apparatus 12 provides printing.

Examples of the information processing terminal 18 include a mobile phone such as a smartphone, a tablet computer, and a personal computer, and the information processing terminal 18 is configured to transmit a document to be printed to the cloud server 14 and request printing when the printing service provided by the cloud server 14 is used. In FIG. 1, a smartphone is depicted as an example of the information processing terminal 18.

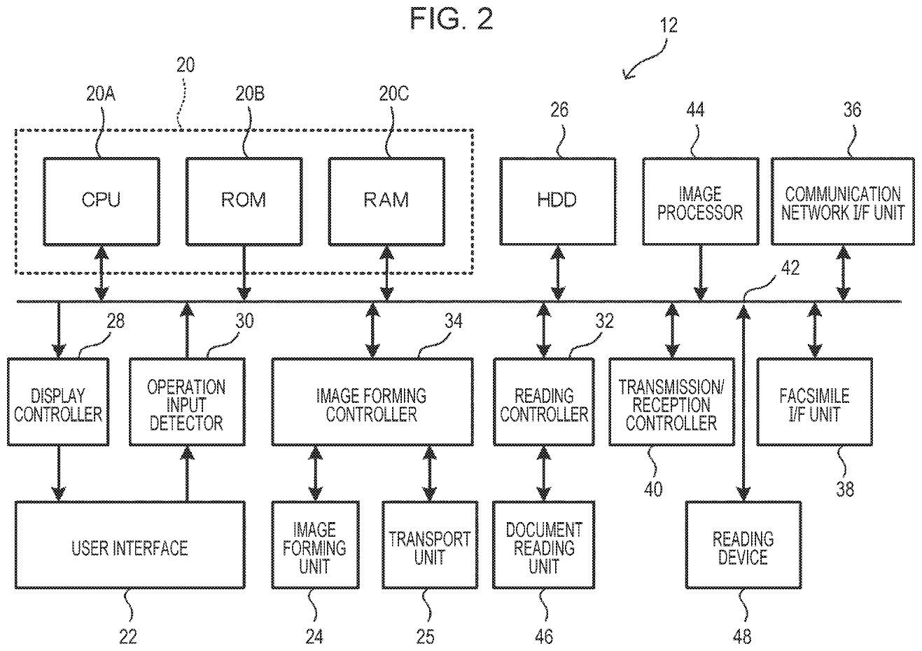

FIG. 2 is a block diagram depicting central components of the electrical system of the image forming apparatus 12 according to the present exemplary embodiment.

The image forming apparatus 12 according to the present exemplary embodiment includes a control unit 20 in which a central processing unit (CPU) 20A, a read only memory (ROM) 20B, and a random access memory (RAM) 20C are included as depicted in FIG. 2. The CPU 20A is configured to manage the overall operation of the image forming apparatus 12. The RAM 20C is a memory such as used as a work area while the CPU 20A executes various programs. The ROM 20B is configured to store various control programs, various parameters, and other data in advance. In the image forming apparatus 12, the components in the control unit 20 are electrically connected to each other by using a system bus 42.

The image forming apparatus 12 according to the present exemplary embodiment includes a hard disk drive (HDD) 26 in which to store various kinds of data, an application program, and other programs. The image forming apparatus 12 also includes a display controller 28 that is connected to a user interface 22 and that is configured to control display of various operation screens and other screens on the display of the user interface 22. The image forming apparatus 12 also includes an operation input detector 30 that is connected to the user interface 22 and that is configured to detect an operation command that is received by the user interface 22. In the image forming apparatus 12, the HDD 26, the display controller 28, and the operation input detector 30 are electrically connected to the system bus 42. Although description will be given with regard to the image forming apparatus 12 according to the present exemplary embodiment, which includes the HDD 26, this is not meant to be limiting, and the image forming apparatus 12 may include a nonvolatile storage device, such as a flash memory.

The image forming apparatus 12 according to the present exemplary embodiment includes a reading controller 32 and an image forming controller 34, the reading controller 32 is configured to control optical image reading by a document reading unit 46 and document transport by a document transport unit, and the image forming controller 34 is configured to control image forming processing by an image forming unit 24 and sheet transport to the image forming unit 24 by a transport unit 25. The image forming apparatus 12 includes a communication network interface (I/F) unit 36 and an image processor 44 configured to perform various kinds of image processing, and the communication network I/F unit 36 is connected to the communication network 16 and is configured to transmit and receive communication data to and from other external devices, such as the cloud server 14, which are connected to the communication network 16. The image forming apparatus 12 includes a facsimile interface (I/F) unit 38 that is connected to a telephone line not depicted and that is configured to transmit and receive facsimile data to and from a facsimile device connected to the telephone line. The image forming apparatus 12 includes a transmission/reception controller 40 configured to control transmission and reception of facsimile data via the facsimile I/F unit 38. The image forming apparatus 12 includes a reading device 48 configured to read identifying information from a card or the information processing terminal 18 capable of short-range wireless communication, such as near-field communication (NFC), the identifying information being associated with the short-range wireless communication. In the image forming apparatus 12, the transmission/reception controller 40, the reading controller 32, the image forming controller 34, the communication network I/F unit 36, the facsimile I/F unit 38, the image processor 44, and the reading device 48 are electrically connected to the system bus 42.

The above configuration enables the CPU 20A to access the RAM 20C, the ROM 20B, and the HDD 26 in the image forming apparatus 12 according to the present exemplary embodiment. The CPU 20A is configured to cause the display controller 28 to control the display of an operation screen and the display of information such as various messages on a display screen of the user interface 22 in the image forming apparatus 12. The CPU 20A is configured to cause the reading controller 32 to control the operation of the document reading unit 46 and the operation of the document transport unit in the image forming apparatus 12. The CPU 20A is configured to cause the image forming controller 34 to control the operation of the image forming unit 24 and the operation of the transport unit 25 and is configured to cause the communication network I/F unit 36 to control transmission and reception of communication data in the image forming apparatus 12. The CPU 20A is configured to cause the transmission/reception controller 40 to control the transmission and reception of facsimile data by facsimile I/F unit 38 in the image forming apparatus 12. The CPU 20A is configured to obtain the details of an operation performed on the user interface 22 based on the operation information detected by the operation input detector 30 and is configured to perform various kinds of control based on the details of the operation in the image forming apparatus 12.

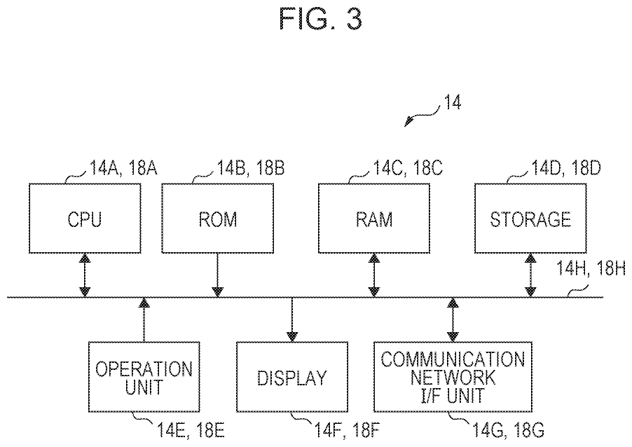

Next, description will be given with regard to the central components of the electrical system of each of the cloud server 14 and the information processing terminal 18 in the information processing system 10 according to the present exemplary embodiment. FIG. 3 is a block diagram depicting the central components of respective electrical systems of the cloud server 14 and the information processing terminal 18 according to the present exemplary embodiment. The cloud server 14 and the information processing terminal 18 are each basically configured as a general-purpose computer, and thus description will be given with regard to the cloud server 14 as a representative example, with the description of the information processing terminal 18 omitted, except that corresponding symbols are depicted for both the cloud server 14 and the information processing terminal 18 in FIG. 3.

The cloud server 14 according to the present exemplary embodiment includes a CPU 14A, a ROM 14B, a RAM 14C, a storage 14D, an operation unit 14E, a display 14F, and a communication network interface (I/F) unit 14G, as depicted in FIG. 3. The CPU 14A manages the overall operation of the cloud server 14. The ROM 14B is configured to store in advance information processing programs for performing various kinds of control, various parameters, and other data. The RAM 14C is a memory such as used as a work area while the CPU 14A executes various programs. The storage 14D is configured to store various kinds of data, application programs, and other data. The operation unit 14E is used to enter various kinds of information. The display 14F is used to display various kinds of information. The communication network I/F unit 14G is connected to the communication network 16 and is configured to transmit and receive various kinds of data to and from other devices connected to the communication network 16. The above components in the cloud server 14 are electrically connected to each other by using a system bus 14H. The cloud server 14 according to the present exemplary embodiment includes the storage 14D as a storage device, and examples of the storage 14D include a nonvolatile storage device, such as an HDD or a flash memory.

The above configuration of the cloud server 14 according to the present exemplary embodiment enables the CPU 14A to access the ROM 14B, the RAM 14C, and the storage 14D, acquire various kinds of data from the operation unit 14E, and cause the display 14F to display various kinds of information. In the cloud server 14, the CPU 14A causes the communication network I/F unit 14G to control transmission and reception of communication data.

When used as the information processing terminal 18, a mobile phone, for example, capable of short-range wireless communication such as NFC serves as an electronic money once an application is installed.

In the information processing system 10 according to the present exemplary embodiment, as described above, the image forming apparatus 12 is installed in a place such as a supermarket or a convenience store, and the cloud server 14 is configured to provide a printing service in which the image forming apparatus 12 prints a document.

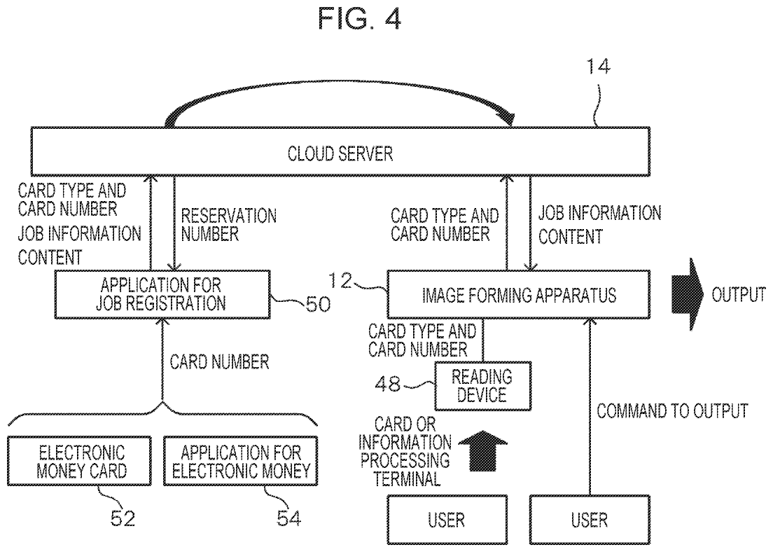

Referring to FIG. 4, description will be given with regard to a printing service provided by the cloud server 14. FIG. 4 is an illustration depicting a schematic configuration of a printing service provided by the cloud server 14 in the information processing system 10 according to the present exemplary embodiment.

As depicted in FIG. 4, when a printing service is used, an application for job registration 50 is installed on the information processing terminal 18, and the application for job registration 50 is configured to send a request for printing to the cloud server 14. In the present disclosure, the term “job” refers to a process or a group of processes to be performed in a service including a printing service provided by the image forming apparatus 12 and the cloud server 14 to achieve a predetermined function.

In the present exemplary embodiment, examples of identifying information associated with a card or the information processing terminal 18 capable of short-range wireless communication include a card number and a card type of an electronic money card 52 or an application for electronic money 54 installed on the information processing terminal 18, and such identifying information of electronic money can be registered in the application for job registration 50.

When a printing service is used, identifying information of electronic money, such as a card type and a card number, job information, and content to be printed are sent from the application for job registration 50 to the cloud server 14, and thereby a print job is requested.

The cloud server 14 is configured to accept a request for a print job sent from the application for job registration 50, issue a reservation number (for example, an eight-digit reservation number), and return the reservation number to the application for job registration 50. The cloud server 14 is also configured to associate the identifying information of electronic money, the job information, and the content with each other and retains these data items.

When a user performs printing and holds the electronic money card 52 or the information processing terminal 18, on which the application for electronic money 54 is installed, over the reading device 48, the reading device 48 reads the identifying information of electronic money by using short-range wireless communication, and the image forming apparatus 12 transmits the identifying information of electronic money to the cloud server 14. Subsequently, the cloud server 14 returns corresponding job information and content to the image forming apparatus 12, and the user enters an output command to the image forming apparatus 12 to perform printing. In response to the output command entered into the image forming apparatus 12, a fee is collected from the electronic money.

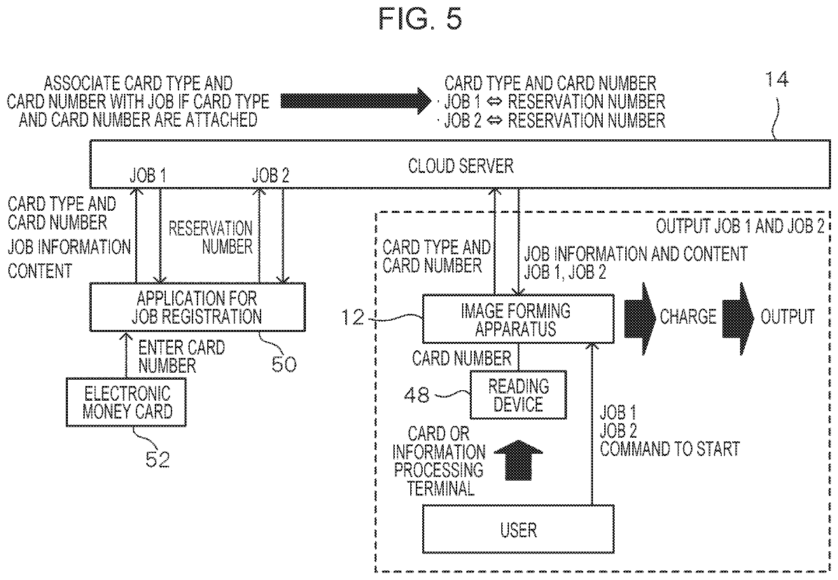

Description will be given with regard to a specific example of a printing service in which two jobs are registered and output. FIG. 5 is an illustration for describing a process of registering two jobs in the cloud server 14 and outputting the two jobs.

A user registers in advance identifying information of electronic money in the application for job registration 50. The identifying information of electronic money needs to be registered only once.

When using a printing service, the user operates the information processing terminal 18 to cause the application for job registration 50 to transmit to the cloud server 14 the identifying information of electronic money, such as a card type and a card number, job information, and content and requests registration of a job.

On accepting a request for a job sent from the application for job registration 50, the cloud server 14 associates the identifying information of electronic money, such as a card type and a card number, with the job, registers the job, and issues a reservation number. As depicted in FIG. 5, when there are multiple jobs, for each job, registration is performed, and a reservation number is issued. Since a reservation number is issued to make a printing service available without identifying information of electronic money, a reservation number need not be issued when identifying information of electronic money is attached to a job.

When identifying information of electronic money is registered in association with a job, reservation numbers for job 1 and job 2 are stored in association with the card type and the card number as depicted in FIG. 5. Alternatively, the reservation number for a job and respective identifying information of electronic money may be associated with each other and stored for each job.

When the user wants to output the registered job, the user holds the electronic money card 52 or the information processing terminal 18, in which the identifying information of electronic money is registered, over the reading device 48 of the image forming apparatus 12, and the reading device 48 reads the identifying information of electronic money, such as the card type and the card number. The identifying information of electronic money read by the reading device 48 is sent from the image forming apparatus 12 to the cloud server 14. Subsequently, the cloud server 14 retrieves the job information and the content registered in association with the identifying information of electronic money and transmits the job information and the content to the image forming apparatus 12.

The image forming apparatus 12 receives and displays the job information and the content that correspond to the identifying information of electronic money.

The user enters commands to start job 1 and job 2 while holding the electronic money card 52 or the information processing terminal 18 over the reading device 48. Then, a fee is collected from the electronic money and the image forming apparatus 12 performs printing.

In this way, since the user only needs to hold the electronic money card 52 or the information processing terminal 18 over the reading device 48 to cause the cloud server 14 to transmit the registered job information and content information to the image forming apparatus 12 in the present exemplary embodiment, the user enjoys better usability in causing the image forming apparatus 12 to execute a registered job than in the case where a mobile terminal apparatus is used to send a command to the image forming apparatus 12 to execute the registered process based on the information obtained from the image of the process-identifying information captured by the imaging function of the mobile terminal apparatus.

When the application for job registration 50 is used as described above, three cases can occur as described below with regard to the output operation of the image forming apparatus 12 depending on whether the information processing terminal 18 is capable of short-range wireless communication, whether the application is installed, and how the application is configured. These cases thus lead to multiple patterns of guidance screen for the user.
(1) No operation is allowed except input of a reservation number.
(2) The electronic money card 52 or the information processing terminal 18 needs to be held over the reading device 48, and input of a reservation number may be omitted instead.
(3) A reservation number needs to be input in the present condition, but if the identifying information of the electronic money card 52 is registered, the case (2) is achieved.

In addition, these cases lead to multiple patterns of operation in the screen of the image forming apparatus 12 for identifying a job (such as input of a reservation number or holding the electronic money card 52 or the information processing terminal 18).

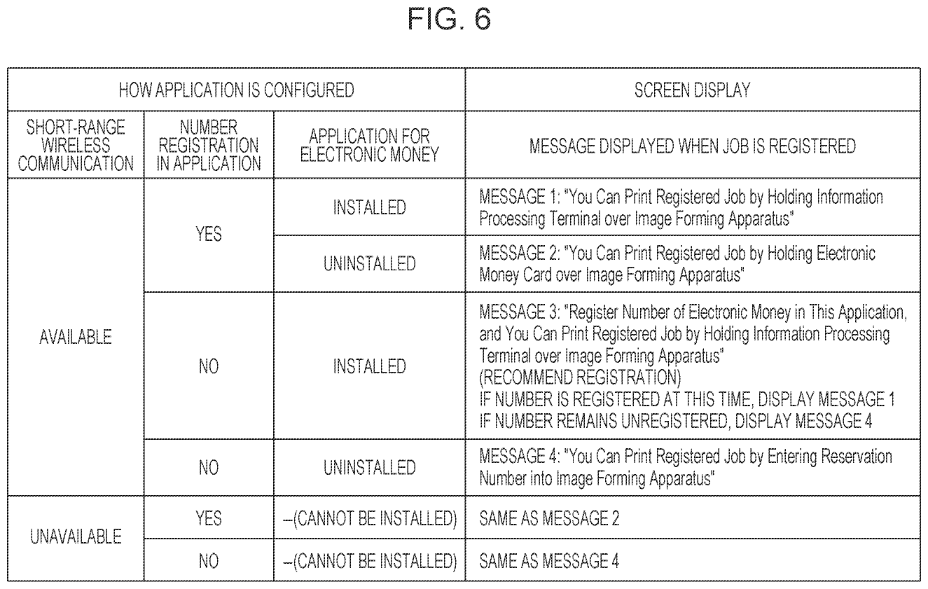

Thus, in the present exemplary embodiment, the screen displayed by the application for job registration 50 when a job is registered is changed appropriately depending on whether the information processing terminal 18 is capable of short-range wireless communication, whether the application is installed, and how the application is configured. Specifically, as depicted in FIG. 6, guidance screens displayed when a job is registered are determined in advance depending on whether the function of short-range wireless communication is available and how the application is configured. FIG. 6 is an illustration depicting examples of the screen that depends on the condition of the information processing terminal 18 and how the application is configured.

In the examples in FIG. 6, if short-range wireless communication is available, the identifying information of electronic money is registered in the application (number registration), and the application for electronic money 54 is installed, then, Message 1 “You Can Print Registered Job by Holding Information Processing Terminal over Image Forming Apparatus” is displayed.

If short-range wireless communication is available, the identifying information of electronic money is registered in the application (number registration), and the application for electronic money 54 is not installed, then, Message 2 “You Can Print Registered Job by Holding Electronic Money Card over Image Forming Apparatus” is displayed.

If short-range wireless communication is available, the identifying information of electronic money is not registered in the application, and the application for electronic money 54 is installed, then, Message 3 “Register Number of Electronic Money in This Application, and You Can Print Registered Job by Holding Information Processing Terminal over Image Forming Apparatus” is displayed. If the identifying information of electronic money is registered in the application at this time, Message 1 above is displayed, and if the identifying information of electronic money remains unregistered, Message 4 below is displayed.

If short-range wireless communication is available, the identifying information of electronic money is not registered in the application, and the application for electronic money 54 is not installed, then, Message 4 “You Can Print Registered Job by Entering Reservation Number into Image Forming Apparatus” is displayed.

If short-range wireless communication is unavailable and the identifying information of electronic money is registered in the application, a message that is the same as Message 2 above is displayed.

If short-range wireless communication is unavailable and the identifying information of electronic money is not registered in the application, a message that is the same as Message 4 above is displayed.

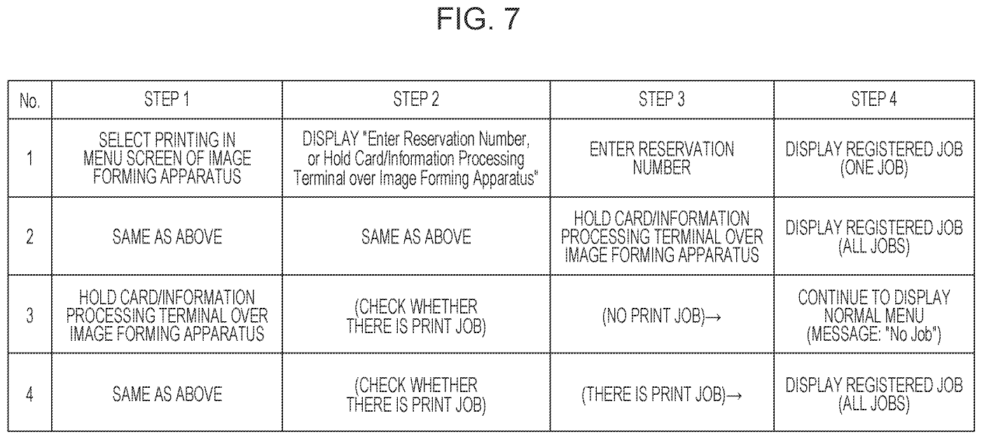

When outputting a job, the image forming apparatus 12 changes screens as depicted in FIG. 7 depending on when the electronic money card 52 or the information processing terminal 18 is held over the image forming apparatus 12, and displays more appropriate screens, leading to better usability. FIG. 7 is an illustration for describing examples of how the screen changes when the image forming apparatus 12 outputs a job. In the examples in FIG. 7, four types of changes in the screen denoted by No. 1 to No. 4 are depicted.

In Case No. 1, when printing is selected in the menu screen of the image forming apparatus 12, the screen displays “Enter Reservation Number, or Hold Electronic Money Card or Information Processing Terminal over Image Forming Apparatus”. If a reservation number is entered at this time, the registered job is displayed. Only one job is displayed.

In Case No. 2, when printing is selected in the menu screen of the image forming apparatus 12, the screen displays “Enter Reservation Number, or Hold Electronic Money Card or Information Processing Terminal over Image Forming Apparatus”. If the electronic money card 52 or the information processing terminal 18 is held over the image forming apparatus 12, the registered job is displayed. All the registered jobs are displayed.

In Case No. 3, when the electronic money card 52 or the information processing terminal 18 is held over the image forming apparatus 12, the image forming apparatus 12 checks with the cloud server 14 whether there is a print job. If there is no registered job, the screen continues to display the normal menu and displays “No Job”.

In Case No. 4, when the electronic money card 52 or the information processing terminal 18 is held over the image forming apparatus 12, the image forming apparatus 12 checks with the cloud server 14 whether there is a print job. If there is a registered job, the registered job is displayed. All the registered jobs are displayed. In this case, the number of screens displayed during the operation is smaller than the number of screens displayed in Case No. 1 or Case No. 2.

Next, description will be given with regard to a specific process performed by each apparatus in the information processing system 10, which is configured as described above, according to the present exemplary embodiment.

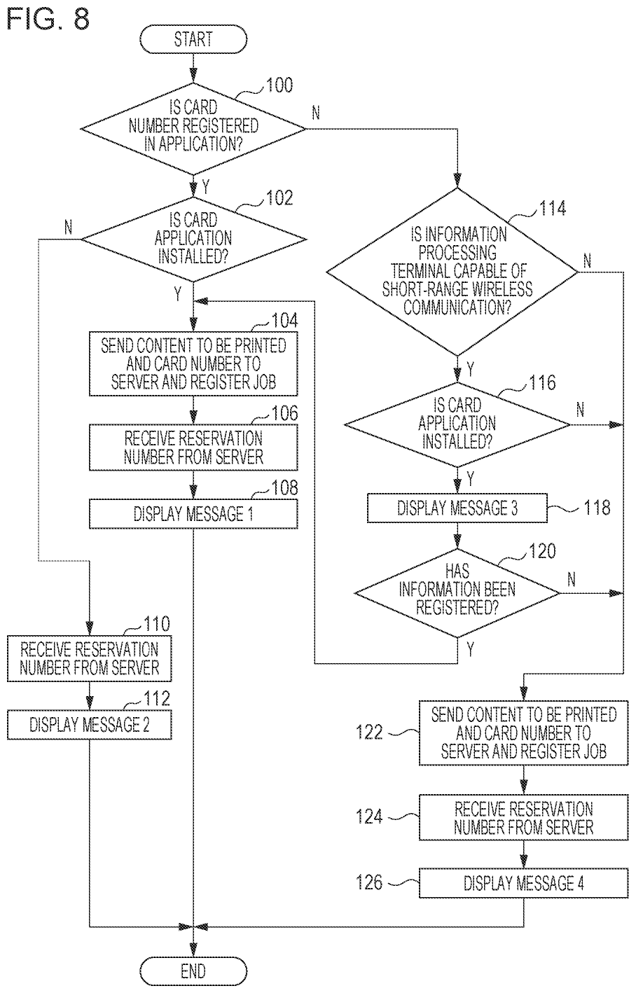

First, description will be given with regard to a process performed by the information processing terminal 18 when a job is registered. FIG. 8 is a flowchart depicting an example of a process performed by the information processing terminal 18 when a job is registered in the information processing system 10 according to the present exemplary embodiment. The process in FIG. 8 starts, for example, when the information processing terminal 18 is operated and a command to register a job is entered into the application for job registration 50.

In step 100, the CPU 18A determines whether a card number of electronic money is registered in the application for job registration 50. It is determined in this step whether identifying information of electronic money is registered. If an affirmative determination is made in step 100, the process proceeds to step 102, and if a negative determination is made in step 100, the process proceeds to step 114.

In step 102, the CPU 18A determines whether a card application is installed. It is determined in this step whether an application for causing the information processing terminal 18 to serve as the electronic money card 52 is installed. If an affirmative determination is made in step 102, the process proceeds to step 104, and if a negative determination is made in step 102, the process proceeds to step 110.

In step 104, the CPU 18A sends content to be printed and the card number to the cloud server 14 to register a job, and the process proceeds to step 106. Specifically, the information processing terminal 18 transmits the identifying information of electronic money, such as the card type and the card number, job information, and content to the cloud server 14.

In step 106, the CPU 18A receives a reservation number from the cloud server 14, and the process proceeds to step 108.

In step 108, the CPU 18A displays Message 1 depicted in FIG. 6 in the screen and completes a series of procedures. Specifically, the display 18F displays the message “You Can Print Registered Job by Holding Information Processing Terminal over Image Forming Apparatus”.

In contrast, in step 110, the CPU 18A receives a reservation number from the cloud server 14, and the process proceeds to step 112.

In step 112, the CPU 18A displays Message 2 depicted in FIG. 6 in the screen and completes a series of procedures. Specifically, the display 18F displays the message “You Can Print Registered Job by Holding Electronic Money Card over Image Forming Apparatus”.

If a negative determination is made in step 100 and the process proceeds to step 114, the CPU 18A determines in step 114 whether the information processing terminal 18 is capable of short-range wireless communication. If an affirmative determination is made in step 114, the process proceeds to step 116, and if a negative determination is made in step 114, the process proceeds to step 122.

In step 116, the CPU 18A determines whether the card application is installed. It is determined in this step whether the application for causing the information processing terminal 18 to serve as the electronic money card 52 is installed. If an affirmative determination is made in step 116, the process proceeds to step 118, and if a negative determination is made in step 116, the process proceeds to step 122.

In step 118, the CPU 18A displays Message 3 depicted in FIG. 6 in the screen and the process proceeds to step 120. Specifically, the display 18F displays the message “Register Number of Electronic Money in This Application, and You Can Print Registered Job by Holding Information Processing Terminal over Image Forming Apparatus”.

In step 120, the CPU 18A determines whether identifying information of electronic money has been registered in the application for job registration 50. If an affirmative determination is made in this step, the process proceeds to step 104 described above, and if a negative determination is made in this step, the process proceeds to step 122.

In step 122, the CPU 18A sends content to be printed and the card number to the cloud server 14 to register a job, and the process proceeds to step 124. Specifically, the information processing terminal 18 transmits the identifying information of electronic money, such as the card type and the card number, job information, and content to the cloud server 14.

In step 124, the CPU 18A receives a reservation number from the cloud server 14, and the process proceeds to step 126.

In step 126, the CPU 18A displays Message 4 depicted in FIG. 6 in the screen and completes a series of procedures. Specifically, the display 18F displays the message “You Can Print Registered Job by Entering Reservation Number into Image Forming Apparatus”.

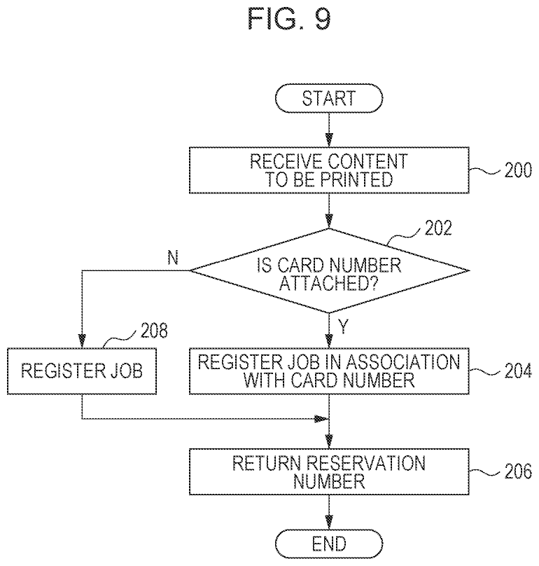

Next, description will be given with regard to a process performed by the cloud server 14 when a job is registered. FIG. 9 is a flowchart depicting an example of a process performed by the cloud server 14 when a job is registered in the information processing system 10 according to the present exemplary embodiment. The process in FIG. 9 starts, for example, when a request for job registration is received from the information processing terminal 18.

In step 200, the CPU 14A receives content to be printed, and the process proceeds to step 202.

In step 202, the CPU 14A determines whether a card number is attached. It is determined in this step whether identifying information of electronic money is attached to the received content. If an affirmative determination is made in step 202, the process proceeds to step 204, and if a negative determination is made in step 202, the process proceeds to step 208.

In step 204, the CPU 14A registers a job in association with the card number, and the process proceeds to step 206. In other words, the job information and the content are registered as a job in association with the identifying information of electronic money, such as the card type and the card number.

In step 206, the CPU 14A returns a reservation number to the information processing terminal 18 and completes a series of procedures.

In contrast, in step 208, the CPU 14A registers a job, and the process proceeds to step 206 described above.

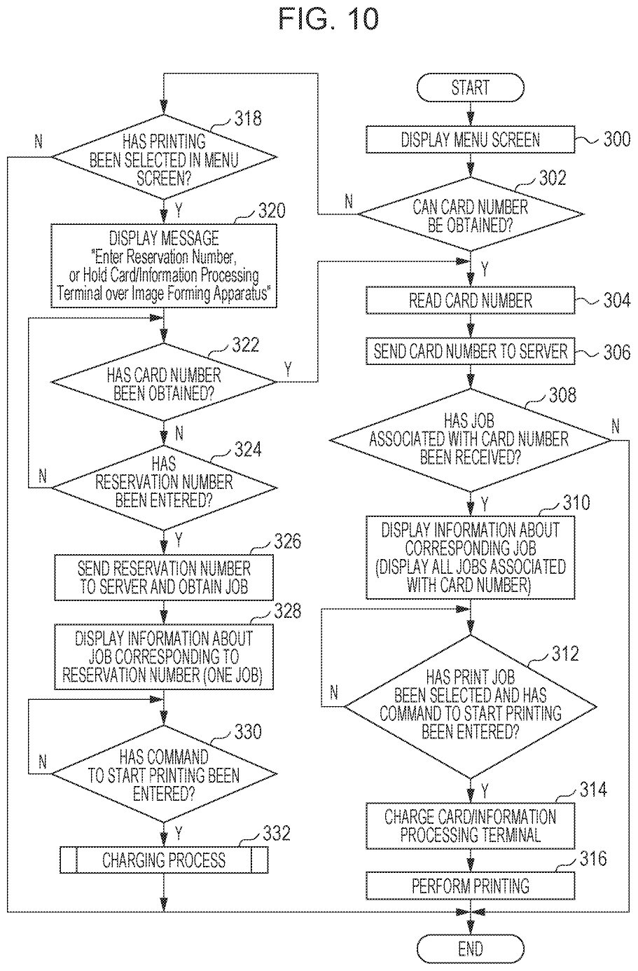

Next, description will be given with regard to a process performed by the image forming apparatus 12 when a registered job is output by the image forming apparatus 12. FIG. 10 is a flowchart depicting an example of a process performed by the image forming apparatus 12 when a registered job is output by the image forming apparatus 12 in the information processing system 10 according to the present exemplary embodiment. The process in FIG. 10 starts, for example, when a user operates the user interface 22 of the image forming apparatus 12.

In step 300, the CPU 20A displays a menu screen, and the process proceeds to step 302. For example, a screen in which to select various services provided by the image forming apparatus 12 is displayed as the menu screen.

In step 302, the CPU 20A determines whether a card number can be obtained. It is determined in this step, for example, whether the reading device 48 can obtain identifying information of electronic money from the electronic money card 52 or the information processing terminal 18 by short-range wireless communication when the user holds the electronic money card 52 or the information processing terminal 18 over the reading device 48. If an affirmative determination is made in step 302, the process proceeds to step 304, and if a negative determination is made in step 302, the process proceeds to step 318.

In step 304, the CPU 20A reads the card number, and the process proceeds to step 306. Specifically, the reading device 48 reads the identifying information of electronic money, such as the card type and the card number, from the electronic money card 52 or the information processing terminal 18, and the process proceeds to step 306.

In step 306, the CPU 20A sends the card number to the cloud server 14, and the process proceeds to step 308. Specifically, the identifying information of electronic money, such as the card type and the card number, read by the reading device 48 is sent to the cloud server 14.

In step 308, the CPU 20A determines whether a job associated with the card number has been received. It is determined in this step whether a job registered in association with the identifying information of electronic money has been received from the cloud server 14. If an affirmative determination is made in step 308, the process proceeds to step 310, and if a negative determination is made in step 308, a series of procedures is completed, and a different process displayed in the menu screen is performed.

In step 310, the CPU 20A displays information about a corresponding job, and the process proceeds to step 312. Specifically, all the jobs registered in association with the identifying information of electronic money are displayed by the user interface 22.

In step 312, the CPU 20A determines whether a print job has been selected and a command to start printing has been entered. It is determined in this step whether the user interface 22 has received the selection of a job to be performed and a command to start the job. The process waits until an affirmative determination is made in step 312 and then proceeds to step 314.

In step 314, the CPU 20A charges the card or the information processing terminal 18 for a fee, and the process proceeds to step 316. Namely, a fee for the job is collected from the electronic money.

In step 316, the CPU 20A performs printing related to the selected job and completes a series of procedures.

In contrast, in step 318, the CPU 20A determines whether printing has been selected in the menu screen. It is determined in this step whether a command has been entered in the menu screen to output a job registered in the cloud server 14 from the image forming apparatus 12. If an affirmative determination is made in step 318, the process proceeds to step 320, and if a different process has been selected in the menu screen in step 318, leading to a negative determination, a series of procedures is completed, and the selected process is performed.

In step 320, the CPU 20A displays a screen, and the process proceeds to step 322. For example, the CPU 20A displays the message “Enter Reservation Number, or Hold Electronic Money Card or Information Processing Terminal over Image Forming Apparatus”.

In step 322, the CPU 20A determines whether the card number has been obtained. It is determined in this step whether the identifying information of electronic money, such as the card type and the card number, has been obtained from the electronic money card 52 or the information processing terminal 18. If an affirmative determination is made in step 322, the process proceeds to step 304 described above, and if a negative determination is made in step 322, the process proceeds to step 324.

In step 324, the CPU 20A determines whether a reservation number has been entered. If a negative determination is made in this step, the process returns to step 322 and repeats the above procedure, and if an affirmative determination is made in this step, the process proceeds to step 326.

In step 326, the CPU 20A sends the reservation number to the cloud server 14 and obtains a job corresponding to the reservation number, and the process proceeds to step 328.

In step 328, the CPU 20A displays information about the job corresponding to the reservation number, and the process proceeds to step 330. Only one job corresponding to the reservation number is displayed at this time.

In step 330, the CPU 20A determines whether a command to start printing has been entered. The process waits until an affirmative determination is made in step 330 and thereafter proceeds to step 332.

In step 332, the CPU 20A performs a charging process and completes a series of procedures. In the charging process, for example, a system such as a point-of-service system is notified of a required fee in a convenience store, and the user pays the fee at the checkout.

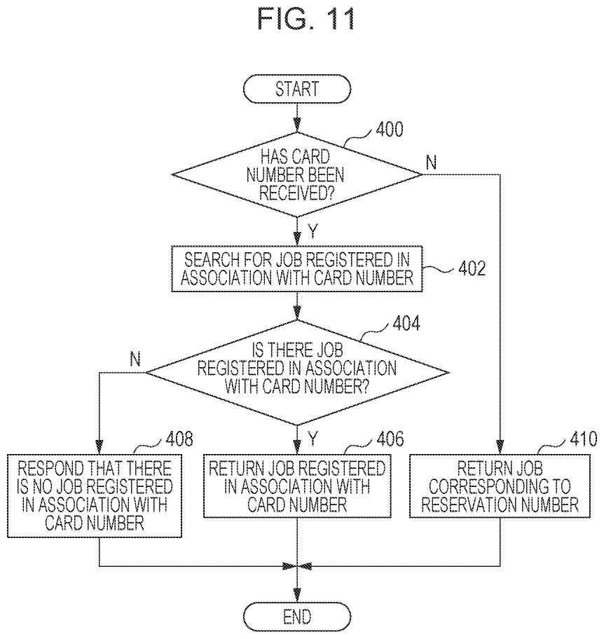

Next, description will be given with regard to a process performed by the cloud server 14 after a job is registered in the cloud server 14. FIG. 11 is a flowchart depicting an example of a process performed by the cloud server 14 after a job is registered in the information processing system 10 according to the present exemplary embodiment. The process in FIG. 11 starts, for example, when a request for job acquisition is received from the image forming apparatus 12.

In step 400, the CPU 14A determines whether a card number has been received. It is determined in this step whether identifying information of electronic money, such as a card type and a card number, has been received from the image forming apparatus 12. When identifying information of electronic money has not been received, a reservation number has been received instead. If an affirmative determination is made in step 400, the process proceeds to step 402, and if a negative determination is made in step 400, in which case a reservation number has been received, the process proceeds to step 410.

In step 402, the CPU 14A searches for a job registered in association with the card number, and the process proceeds to step 404.

In step 404, the CPU 14A determines whether there is a job registered in association with the card number. If an affirmative determination is made in step 404, the process proceeds to step 406, and if a negative determination is made in step 404, the process proceeds to step 408.

In step 406, the CPU 14A returns the job registered in association with the card number to the image forming apparatus 12 and completes a series of procedures.

In step 408, the CPU 14A responds to the image forming apparatus 12 that there is no job registered in association with the card number and completes a series of procedures.

In contrast, if a reservation number has been received in step 400, in which case a negative determination is made in step 400, and the process proceeds to step 410, the CPU 14A returns a job corresponding to the reservation number to the image forming apparatus 12 in step 410 and completes a series of procedures.

In the present exemplary embodiment, identifying information of electronic money in the electronic money card 52 or the application for electronic money 54 has been described as a non-limiting example of identifying information associated with the card or the information processing terminal 18 capable of short-range wireless communication. For example, the identifying information may be information for identifying a card other than the electronic money or information for identifying the information processing terminal 18.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process performed by each unit in the information processing system 10 according to the exemplary embodiment above may be a process performed by using software, a process performed by using hardware, or a process performed by using a combination of software and hardware. The process performed by each unit in the information processing system 10 may be stored in a recording medium as a program and distributed by using the recording medium.

The present disclosure is not limited to the above exemplary embodiment, and various modifications to the above exemplary embodiment may obviously be practiced as long as they do not depart from the spirit of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   in accepting registration of a process to be performed by a processing apparatus, receive identifying information of a card or an information processing terminal capable of wireless communication and information to be handled in the process and register the process in association with the identifying information, the identifying information being associated with the wireless communication;
   in performing the registered process, receive the identifying information obtained by the processing apparatus via the wireless communication from the card or the information processing terminal; and
   transmit to the processing apparatus the information to be handled in the process registered in association with the received identifying information.
      (((2)))

The information processing system according to (((1))),
wherein the identifying information is identifying information of electronic money.
   (((3)))

The information processing system according to (((2))),
wherein the processor is configured to collect a charge for the process from the electronic money corresponding to the identifying information.
   (((4)))

The information processing system according to any one of (((1))) to (((3))),
wherein the processor is configured to, in accepting registration of the process, receive the identifying information and the information to be handled in the process from an information processing terminal in which the identifying information has been registered in advance.
   (((5)))

The information processing system according to (((4))),
wherein the processor is configured to, in accepting the registration of the process, cause the information processing terminal to display a screen determined in advance based on whether an application is installed onto the information processing terminal and how the application is configured.
   (((6)))

The information processing system according to any one of (((1))) to (((5))),
wherein the processor is configured to, in accepting registration of the process, issue a reservation number for the process if the identifying information is not received and in performing the registered process, receive the reservation number from the processing apparatus and transmit to the processing apparatus the information to be handled in the process corresponding to the reservation number.
   (((7)))

A program causing a computer to execute a process for information processing, the process comprising:

in accepting registration of a process to be performed by a processing apparatus, receiving identifying information of a card or an information processing terminal capable of wireless communication and information to be handled in the process and registering the process in association with the identifying information, the identifying information being associated with the wireless communication;

in performing the registered process, receiving the identifying information obtained by the processing apparatus via the wireless communication from the card or the information processing terminal; and
transmitting to the processing apparatus the information to be handled in the process registered in association with the received identifying information.

What is claimed is:

1. An information processing system comprising:
a processor configured to:
in accepting registration of a process to be performed by a processing apparatus, receive identifying information of a card or an information processing terminal capable of wireless communication and information to be handled in the process and register the process in association with the identifying information, the identifying information being associated with the wireless communication;
in performing the registered process, receive the identifying information obtained by the processing apparatus via the wireless communication from the card or the information processing terminal; and
transmit to the processing apparatus the information to be handled in the process registered in association with the received identifying information.

2. The information processing system according to claim 1,
wherein the identifying information is identifying information of electronic money.

3. The information processing system according to claim 2,
wherein the processor is configured to collect a charge for the process from the electronic money corresponding to the identifying information.

4. The information processing system according to claim 1,
wherein the processor is configured to, in accepting registration of the process, receive the identifying information and the information to be handled in the process from an information processing terminal in which the identifying information has been registered in advance.

5. The information processing system according to claim 4,
wherein the processor is configured to, in accepting the registration of the process, cause the information processing terminal to display a screen determined in advance based on whether an application is installed onto the information processing terminal and how the application is configured.

6. The information processing system according to claim 1,
wherein the processor is configured to, in accepting registration of the process, issue a reservation number for the process if the identifying information is not received and in performing the registered process, receive the reservation number from the processing apparatus and transmit to the processing apparatus the information to be handled in the process corresponding to the reservation number.

7. A non-transitory computer readable medium storing a program causing a computer to execute a process for information processing, the process comprising:
in accepting registration of a process to be performed by a processing apparatus, receiving identifying information of a card or an information processing terminal capable of wireless communication and information to be handled in the process and registering the process in association with the identifying information, the identifying information being associated with the wireless communication;
in performing the registered process, receiving the identifying information obtained by the processing apparatus via the wireless communication from the card or the information processing terminal; and
transmitting to the processing apparatus the information to be handled in the process registered in association with the received identifying information.

8. An information processing method comprising:
in accepting registration of a process to be performed by a processing apparatus, receiving identifying information of a card or an information processing terminal capable of wireless communication and information to be handled in the process and registering the process in association with the identifying information, the identifying information being associated with the wireless communication;
in performing the registered process, receiving the identifying information obtained by the processing apparatus via the wireless communication from the card or the information processing terminal; and
transmitting to the processing apparatus the information to be handled in the process registered in association with the received identifying information.
